(19) United States
(12) Patent Application Publication
(10) Pub. No.: US 2006/0271951 A1
(43) Pub. Date: Nov. 30, 2006

(54) Display control apparatus, method thereof and program product thereof

(75) Inventor: Tomonori Ishizaki, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/418,952

(22) Filed: May 5, 2006

(30) Foreign Application Priority Data
May 6, 2005 (JP) P2005-134718

(51) Int. Cl. H04N 7/025; G06F 3/00; G06F 13/00; H04N 7/10; H04N 7/16; H04N 7/173; H04N 5/445

(52) U.S. Cl. 725/32; 725/100; 725/131; 725/134; 725/142; 725/34; 725/58

(57) ABSTRACT

When display switching is instructed in a state that a program schedule according to time is displayed, in which a time axis is set in a horizontal direction and a channel axis is set in a vertical direction, respectively, a program schedule according to channels is displayed in which the time axis is set in the horizontal direction and the channel axis is set in the vertical direction, respectively. In the program schedule, a wider area than other channels is assigned to the channel which has been focused in the program schedule according to time, and information of programs broadcasted by the channel are displayed at positions corresponding to broadcast time of the programs, respectively. The invention can be applied to equipment capable of displaying an EPG, such as a digital television receiver, a hard disk recorder, or a DVD recorder.

### CROSS REFERENCE TO RELATED APPLICATIONS

The present application claims priority from Japanese Patent Application No. JP 2005-134718 filed on May 6, 2005, the disclosure of which is hereby incorporated by reference herein.

### BACKGROUND OF THE INVENTION

The invention relates to a display control apparatus, a method thereof, and a program product thereof, especially relates to a display control apparatus, a method thereof, and a program product thereof in which a display of a program schedule can be switched seamlessly without a sense of incongruity.

In related arts, as display forms of a program schedule, for example, there are a display according to time and a display according to channels. In the display according to time, a certain time slot such as one hour is focused and titles of programs broadcasted at that time in respective channels are displayed in a list. In the display according to channels, a certain channel is focused and titles of programs broadcasted in the channel at respective time slots are displayed in a list.

For example, as shown in “DVD Recorder With Hard Disk ‘Sugoroku’, Electronic Program Schedule (EPG)/Program Tracking Recording,” (http://www.sony.jp/products/Consumer /dvdrecorder/products/rdr_h×100_hx90.html), in a program schedule according to time, a time axis is set in a horizontal direction, and in a program schedule according to channels, a time axis is set in a vertical direction.

However, when searching a program from the program schedule, by switching the display alternately between the program schedule according to time and the program schedule according to channels, the time axis is switched from the horizontal direction to the vertical direction, or from the vertical direction to the horizontal direction, therefore, a user has to search the program while changing consciousness for the time direction, which make him/her feel incongruous.

The invention is capable of switching a display of a program schedule seamlessly without a sense of incongruity.

### SUMMARY OF THE INVENTION

The invention includes a display control unit/step which, when display switching is instructed in a state that information of programs broadcasted in plural channels are displayed at positions corresponding to the broadcast time of respective programs by setting a time axis in a predetermined direction and setting a channel axis in a direction orthogonal to the predetermined direction, displays information of programs broadcasted in a focused channel at positions corresponding to the broadcast time of respective programs by setting the time axis in the same direction as the predetermined direction, and displays information of programs by switching the focused channel in accordance with operations in the direction orthogonal to the predetermined direction by a user.

The display control unit also can display frames indicating the broadcast time of programs broadcasted in different channels from the focused channel at positions corresponding to the broadcast time of respective programs, can display detailed information of a focused program at a designated position, or can display a program which has been watched just before the information of programs are displayed at a designated position.

It is possible that information of programs includes picture images concerning the programs.

In the invention, when display switching is instructed in a state that information of programs broadcasted in plural channels are displayed at positions corresponding to the broadcast time of respective programs by setting a time axis in a predetermined direction and setting a channel axis in a direction orthogonal to the predetermined direction information of programs broadcasted in a focused channel are displayed at positions corresponding to the broadcast time of respective programs by setting the time axis in the same direction as the predetermined direction, and information of programs are displayed by switching the focused channel in accordance with operations in the direction orthogonal to the predetermined direction by a user.

According to the invention, a display of the program schedule can be switched seamlessly without a sense of incongruity.

### BRIEF DESCRIPTION OF THE DRAWINGS

FIG. 1 is a block diagram showing a configuration example of a DTV according to an embodiment of the invention;

FIG. 2 is a view showing an example of a program schedule according to time;

FIG. 3 is a view showing an example of a program schedule according to channels;

FIG. 4 is a view showing another example of the program according to channels;

FIG. 5 is a view showing another example of the program according to channels;

FIG. 6 is a view showing an example of the program schedule according to time;

FIG. 7 is a view showing another example of the program schedule according to time;

FIG. 8 is a flow chart explaining display switching processing; and

FIG. 9 is a block diagram showing a configuration example of a computer.

### DETAILED DESCRIPTION

Hereinafter, embodiments of the invention will be described, and correspondence relation between the invention described in the specification and embodiments of the invention is represented as follows. This description is made for verifying that embodiments supporting the invention described in claims are described in the specification. Therefore, even if there is an embodiment which is not described here as the embodiment corresponding to the invention through it is described in embodiments of the invention, that does not mean that the embodiment does not correspond to the invention. Conversely, even if the embodiment is described here as the embodiment corresponding to the invention, that does not mean that the embodiment does not correspond to other inventions other than this invention.

Further, the description does not mean the whole invention described in the specification. In other words, the description does not deny existence of the inventions described in the specification and not claimed in the application, namely, inventions of divisional application or additional inventions by amendment in the future.

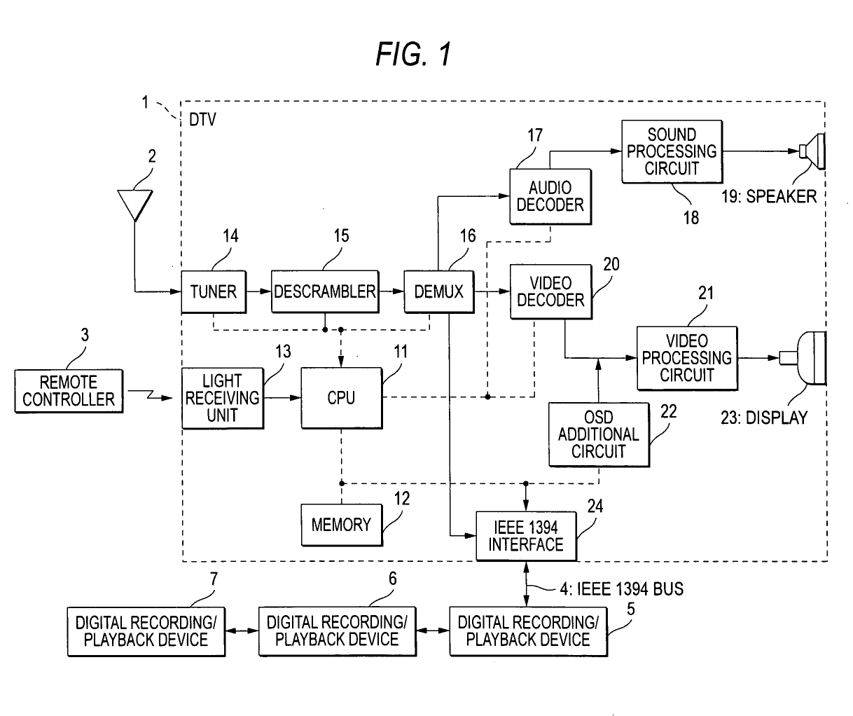

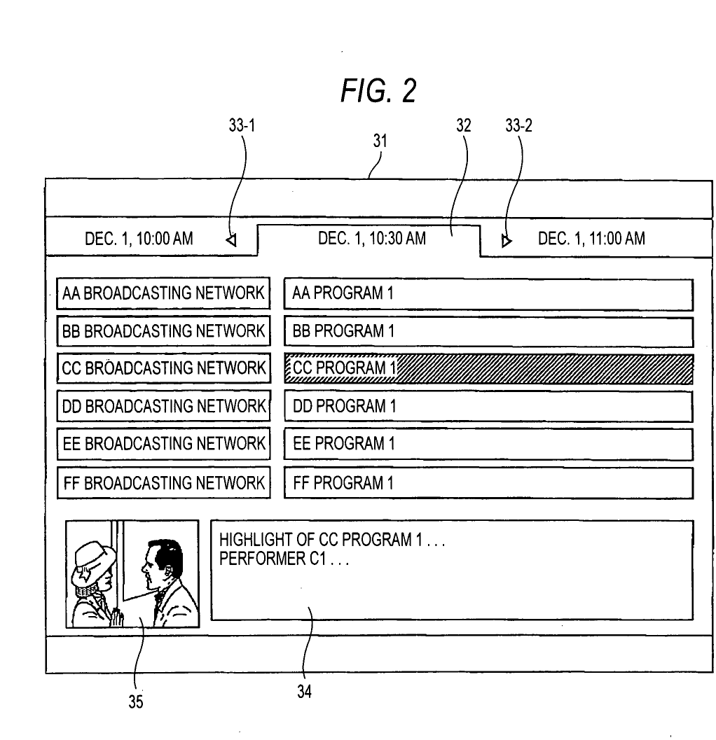

A display control apparatus according to an embodiment of the invention (for example, a DTV 1 of FIG. 1) has a display control unit (for example, an OSD additional circuit 22 of FIG. 1) which, when display switching is instructed in a state that information of programs broadcasted in plural channels are displayed at positions corresponding to broadcast time of respective programs (for example, a state in which a program schedule 31 of FIG. 2 is displayed) by setting a time axis in a predetermined one direction (for example, a horizontal direction) and setting a channel axis in a direction orthogonal to the predetermined one direction (for example, a vertical direction), displays information of programs (for example, a CC program 1 to a CC program 4) broadcasted in a focused one channel (for example, a “CC broadcasting network” in the program schedule 31 shown in FIG. 2) at positions corresponding to broadcast time of respective programs by setting the time axis in the same direction as the predetermined one direction, and displays information of programs by switching the focused channel in accordance with operations in the direction orthogonal to the predetermined one direction by a user.

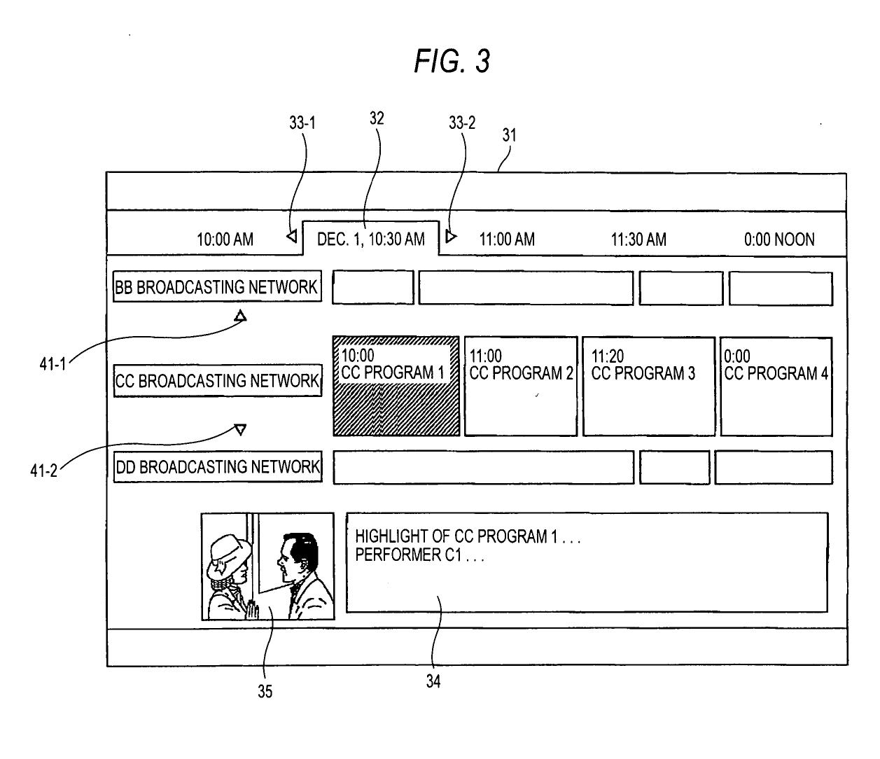

The display control unit of the display control apparatus according to an embodiment of the invention also displays frames indicating broadcast time of programs broadcasted in different channels from the focused one channel (for example, a “BB broadcasting network” and a “DD broadcasting network” in the program schedule 31 shown in FIG. 3) at positions corresponding to broadcast time of respective programs.

The display control unit of the display control apparatus according to an embodiment of the invention also displays detailed information of a focused one program at a designated position (for example, a detailed information display area 34 in FIG. 3).

The display control unit of the display control apparatus according to an embodiment of the invention also displays a program which has been watched just before the information of programs are displayed at a designated position (for example, a watching area 35 in FIG. 3).

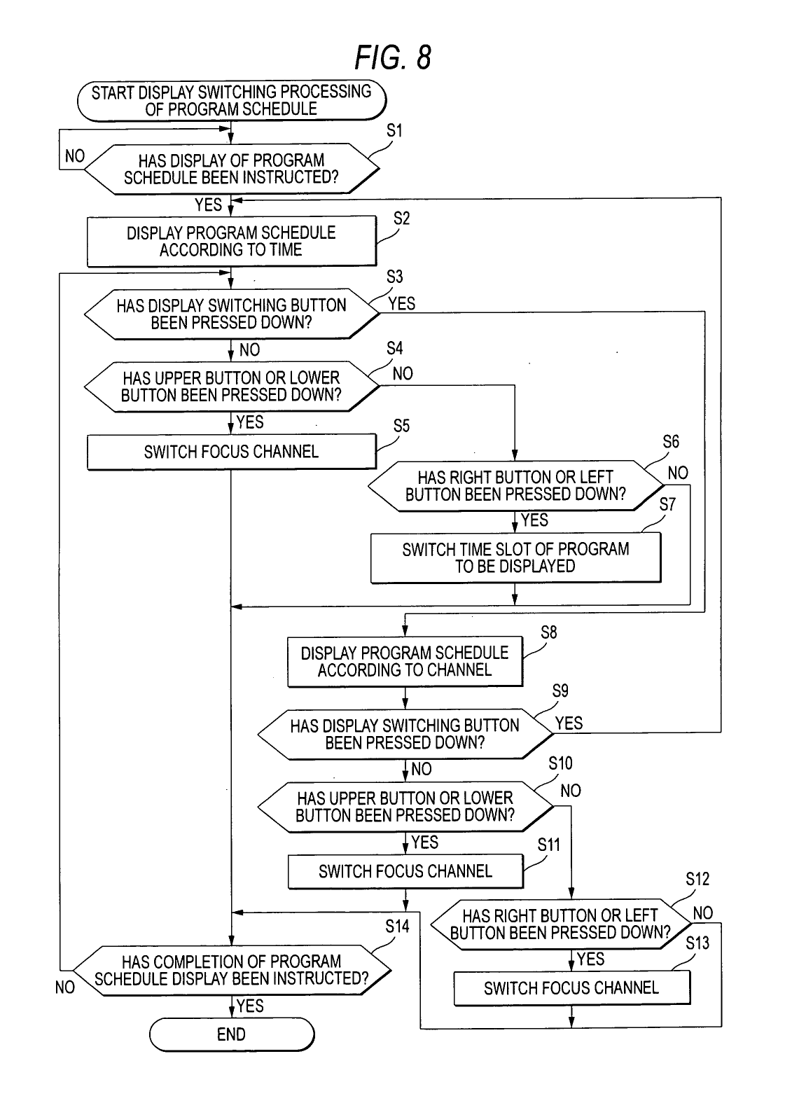

A display control method according to an embodiment of the invention includes a display control step (for example, step S8 in FIG. 8) of, when display switching is instructed in a state that information of programs broadcasted in plural channels are displayed at positions corresponding to broadcast time of respective programs by setting a time axis in a predetermined one direction and setting a channel axis in a direction orthogonal to the predetermined one direction, displaying information of programs broadcasted in a focused one channel at positions corresponding to broadcast time of respective programs by setting the time axis in the same direction as the predetermined one direction, and displaying information of programs by switching the focused channel in accordance with operations in the direction orthogonal to the predetermined one direction by a user.

In a program according to an embodiment of the invention, an embodiment (one example) to which respective steps corresponds is the same as the display control method according to an embodiment.

Hereinafter, an embodiment of the invention will be explained with reference to the drawings.

FIG. 1 is a block diagram showing a configuration example of a DTV (Digital Television) 1 according to an embodiment of the invention.

A CPU (Central Processing Unit) 11 executes programs stored in a memory 12, controlling the whole operation of the DTV 1 according to signals supplied from a light receiving unit 13.

The light receiving unit 13 receives infrared rays from a remote controller 3 and outputs a signal obtained by demodulation, corresponding to a user's operation to the CPU 11.

A tuner 14 receives and demodulates a broadcasting signal from an antenna 2 in accordance with control of the CPU 11, outputting a transport stream (TS) broadcasted in a designated channel to a descrambler 15.

The descrambler 15 generates a key for the descrambling by using data stored in a CAS card not shown to descramble the transport stream supplied from the tuner 14. The transport stream descrambled by the descrambler 15 is supplied to a DEMUX (demultiplexer) 16.

The DEMUX 16 extracts a designated stream from the transport stream supplied from the descrambler 15 in accordance with the control by the CPU 11, outputting the extracted stream (packets included in the stream) to an audio decoder 17 and a video decoder 20.

The DEMUX 16, when recording contents in digital recording/playback devices 5 to 7, outputs the obtained stream to an IEEE (Institute of Electrical and Electronics Engineers 1394 interface 24, and when reproducing contents recorded in the digital recording/playback devices 5 to 7, outputs a stream supplied from the digital recording/playback devices 5 to 7 to the audio decoder 17 and the video decoder 20 through an IEEE 1394 bus 4 and the IEEE 1394 interface 24.

The audio decoder 17 decodes audio data (audio packets) supplied from the DEMUX 16 and outputs the obtained audio data to a sound processing circuit 18.

The sound processing circuit 18 performs D/A (Digital/Analog) conversion, amplification processing and the like with respect to the audio data supplied from the audio decoder 17, outputting the obtained sound to a speaker 19.

The video decoder 20 decodes video data (video packets) supplied from the DEMUX 16 and outputs the obtained video data to a video processing circuit 21.

The video processing circuit 21 performs predetermined image processing, D/A conversion and the like with respect to the video data supplied from the video decoder 20, displaying images of contents in a display 23. The video processing circuit 21 displays a designated image in the display 23 also based on video data supplied from an OSD (On Screen Display) additional circuit 22.

The OSD additional circuit 22 generates video data of images to be displayed in the display 23 in accordance with control of the CPU 11, outputting the video data to the video processing circuit 21. For example, video data for displaying the program schedule is generated by the OSD additional circuit 22, which is outputted to the video processing circuit 21.

The IEEE 1394 interface 24 performs communication with digital recording/playback devices 5 to 7 including a HDR (Hard Disk Recorder), DVHS (Digital Video Home System) and the like through the IEEE 1394 bus. For example, an AV/C command supplied by the CPU 11, a stream supplied by the DEMUX 16 and the like are transmitted from the IEEE 1394 interface 24 to the digital recording/playback devices 5 to 7.

Next, a basic operation of the DTV 1 having the above configuration will be explained.

When watching normal digital broadcasting, the remote controller 3 is operated by a user and a designated broadcasting station is selected, then, infrared rays from the remote controller 3 are received at the light receiving unit 13, and a station selection signal obtained by demodulation is transmitted to the tuner 14 through the CPU 11. The tuner 14 selects the broadcasting station according to the station selection signal and allows the antenna 2 to receive image information transmitted in a modulated transport stream format, then, demodulates the information. When the transport stream is encrypted such as in a pay television, the descrambling is performed by the descrambler 15 and the designated stream is extracted by the DEMUX 16. The extracted audio data is decoded by the audio decoder 17 and the extracted video data is decoded by the video decoder 20.

When receiving data broadcasting, a data broadcasting signal demultiplexed by the DEMUX 16 is transmitted to the OSD additional circuit 22 through the CPU 11, and a data broadcasting picture display signal is generated there. After the data broadcasting picture display signal generated at the OSD additional circuit 22 is added to the video data decoded by the video decoder 20, a designated image is displayed in the display 23. Sound decoded by the audio decoder 17 is outputted from the speaker 19 through the sound processing circuit 18.

Program schedule data is acquired from airwaves received by the antenna 2. The acquired program schedule data is stored in the memory 12, read-out appropriately to be used for the display of a program schedule.

FIG. 2 is a view showing a display example of a program schedule 31 which is displayed in the display 23 of the DTV 1.

In an upper part of the program schedule 31 shown in FIG. 2, “Dec. 1, 10:00 AM”, “Dec. 1, 10:30 AM”, and “Dec. 1, 11:00 AM” are displayed in a tab, and titles of programs broadcasted at a date and time selected by a user are displayed according to channels. That is, the display in FIG. 2 corresponds to the above-described display according to time. In the display according to time, a time axis is set in a horizontal direction and a channel axis is set in a vertical direction orthogonal to the horizontal direction.

In the example of FIG. 2, a tab 32 of “Dec. 1, 10:30 AM” is selected by the user, and titles of respective programs are displayed, which will be broadcasted at an AA broadcasting network to a FF broadcasting network in a time slot of December 1, from 10:30 AM to 11:00 AM.

A left mark 33-1 and a right mark 33-2 indicate that the time slot can be moved to adjacent time slots. For example, when a user presses down a left button of the remote controller 3 under a state of FIG. 2 in which the tab 32 of “Dec. 1, 10:30 AM” is selected, a tab of “Dec. 1, 10:00 AM” is selected, and titles of respective programs are displayed at the center of the screen, which will be broadcasted by the AA broadcasting network to the FF broadcasting network at the time slot from December 1, 10:00 AM to 10:30 AM. On the other hand, the user pressed down a right button of the remote controller 3 under the state of FIG. 2, a tab of “Dec. 1, 11:00 AM” is selected, and titles of respective programs are displayed at the center of the screen, which will be broadcasted by the AA broadcasting network to the FF broadcasting network at the time slot from December 1, 11:00 AM to 11:30 AM.

In the example of FIG. 2, a “CC program 1” (a colored portion) broadcasted by the “CC broadcasting network” is focused by operation of the remote controller 3 by the user, and detailed information of the title is displayed in a detailed information display area 34 at a lower side of the screen. In a watching area 35 at a left side of the detailed information display area 34, a program which has been watched by the user just before the display of the program schedule 31 is displayed.

FIG. 3 is a view showing a display example of the program schedule 31 which is displayed, for example, when the user presses down a display switching button of the remote controller 3 in a state in which a program schedule of FIG. 2 according to time is displayed.

In the program schedule 31 shown in FIG. 3, “Dec. 1, 10:00 AM”, “Dec. 1, 10:30”, “Dec. 1, 11:00 AM”, “Dec. 1, 11:30”, and “Dec. 1, 0:00 Noon” are displayed in a tab at the same position of the program schedule shown in FIG. 2. An area wider than other channels is assigned to the “CC broadcasting network” as the channel which has been focused just before the program schedule 31 is displayed (just before the display switching button is pressed down), and information of respective programs which will be broadcasted by the “CC broadcasting network” are displayed at positions corresponding to broadcast time of respective programs. That is, the display in FIG. 3 corresponds to the above-described display according to channels. In the display according to channels, the time axis is set in the horizontal axis direction in the same way as the display according to time in FIG. 2.

In the example of FIG. 3, titles and broadcast start time of the programs are displayed as information of the CC program 1 to a CC program 4 which will be broadcasted by the “CC broadcasting network”. The “CC program 1” in the CC program 1 to the CC program 4 as the program which has been focused just before the program schedule 31 is displayed is focused continuously.

Above and below the “CC broadcasting network” displayed with the wider area assigned, frames are displayed, by which the user can check that there are programs which will be broadcasted at the time slots as information of the “BB broadcasting network” and the “DD broadcasting network” as channels not focused, which are adjacent to the “CC broadcasting network” (for example, adjacent in the order of channel numbers). Naturally, it is preferable that not only frames but also information such as titles, broadcast start time of the programs and the like are displayed in the frames, and information can be displayed in a smaller size than the size (size of characters and the like) of information of the program broadcasted by the “CC broadcasting network” which is focused.

An upper mark 41-1 and a lower mark 41-2 displayed above and below characters of the “CC broadcasting network” indicate that the channel to be focused can be moved to adjacent channels. For example, when the user presses down the upper button of the remote controller 3 in the state of FIG. 3 in which the “CC broadcasting network” is focused, an object to be focused is switched to the “BB broadcasting network”, and information of programs broadcasted by “BB broadcasting network” are displayed at positions corresponding to respective broadcast time instead of the display of information of the programs broadcasted by the “CC broadcasting network” until then. On the other hand, when user presses down the lower button of the remote controller 3 in the state of FIG. 3, an object to be focused is switched to “DD broadcasting network”, information of programs broadcasted by the “DD broadcasting network” are displayed at positions corresponding to respective broadcast time instead of the display of information of programs broadcasted by the “CC broadcasting network” until then.

It is also preferable that not only titles and broadcast start time but also typical pictures (still pictures) of programs are displayed as information of respective programs broadcasted in a channel which is focused.

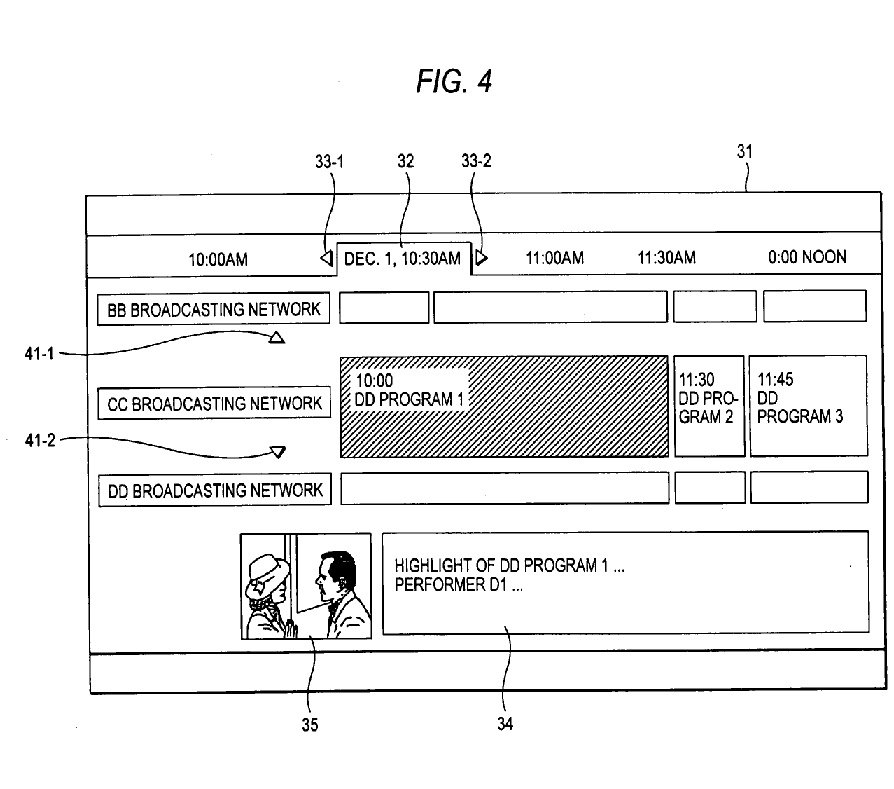

FIG. 4 is a view showing a display example of the program schedule 31 displayed, for example, when the user presses down the lower button of the remote controller 3 in the state that the program schedule of FIG. 3 is displayed.

In the case of the example of FIG. 4, a wide area is assigned to the “DD broadcasting network” and an object to be focused is switched to a “DD program 1” which will be broadcasted at the same time as the “CC program 1” as the program which has been focused in the state of FIG. 3. According to the switching of the program as the object to be focused, the display of the detailed information display area 34 is switched from detailed information of the “CC program 1” to detailed information of the “DD program 1”.

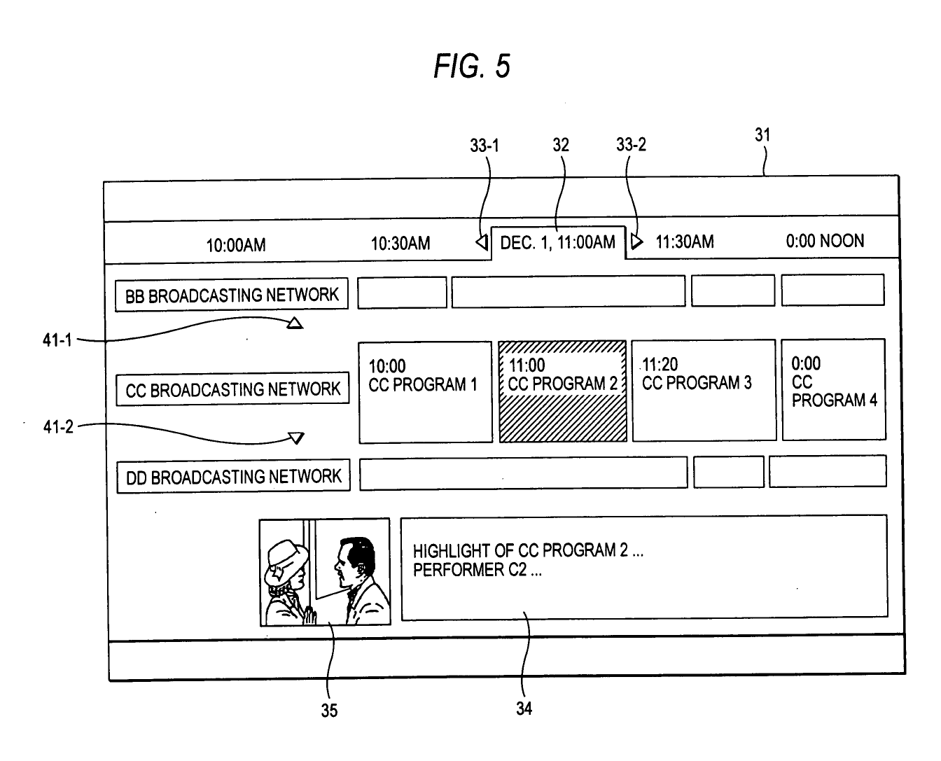

FIG. 5 is a view showing a display example of the program schedule 31 displayed, for example, when the user presses down the right button of the remote controller 3 in the state that the program schedule of FIG. 3 is displayed.

In the case of the example of FIG. 5, an object to be focused is switched from the “CC program 1” to a “CC program 2”, and the tab 32 of “Dec. 1, 11:00 AM” is selected, which is a time slot when the “CC program 2” is broadcasted. According to the switching of the program as the object to be focused, the display of the detailed information display area 34 is switched from detailed information of the “CC program 1” to detailed information of the “CC program 2”.

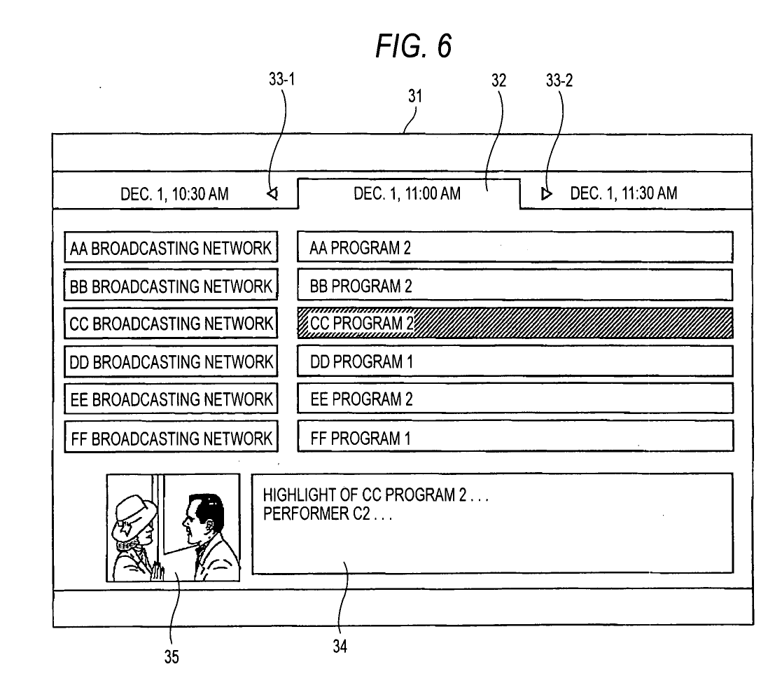

FIG. 6 is a view showing a display example of the program schedule 31 displayed, for example, when the user presses down the display switching button of the remote controller 3 in the state that the program schedule of FIG. 5 is displayed. At this time, a display form is switched from the display according to channels to the display according to time.

In the case of the example of FIG. 6, titles of respective programs broadcasted by the “AA broadcasting network” to the “FF broadcasting network” at a time slot from December 1, 11:00 AM to 11:30 AM are displayed, and the program in the channel which has been focused just before the program schedule 31 is displayed (just before the display switching button is pressed down) is focused continuously (in this case, the “CC program 2” broadcasted by the “CC broadcasting network” (FIG. 5)).

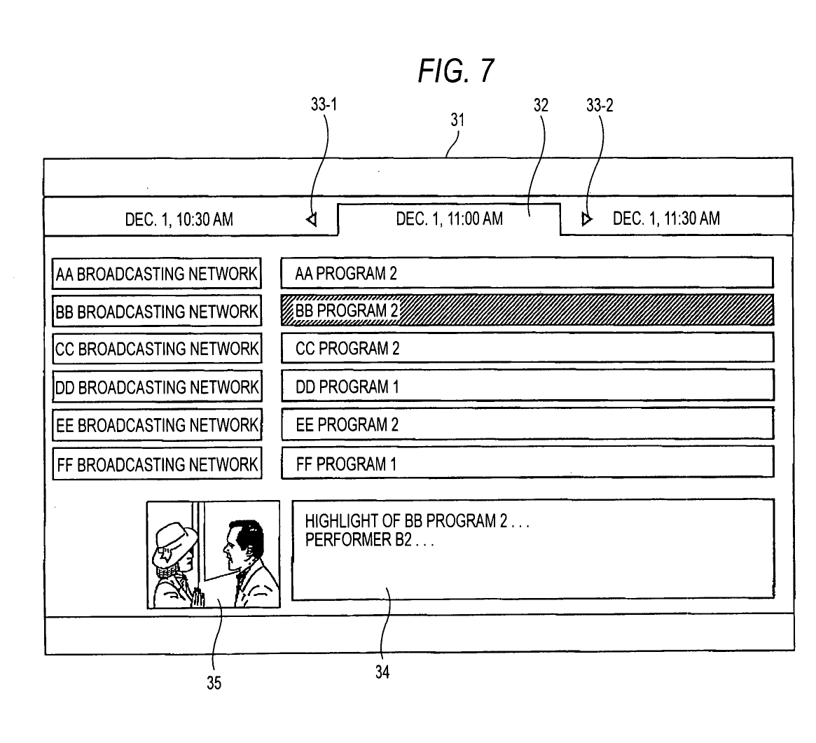

FIG. 7 is a view showing a display example of the program schedule 31 displayed, for example, when the user presses down the upper button of the remote controller 3 in the state that the program schedule of FIG. 6 is displayed.

In the case of the example of FIG. 7, an object to be focused is switched from the “CC program 2” broadcasted by the “CC broadcasting network” to a “BB program 2” broadcasted by the “BB broadcasting network”. According to the switching of the program as the object to be focused, the display of the detailed information display area 34 is switched from detailed information of the “CC program 2” to detailed information of the “BB program 2”.

When the user, for example, presses down the left button of the remote controller 3 in the state that the program schedule 31 of FIG. 6 is displayed, the time slot to be focused is switched and the program schedule 31 as shown in FIG. 2 is displayed. In the same manner, the display form (display according to time or display according to channels) or the position of the object to be focused is switched according to the user's operation.

As described above, the user can easily switch the program schedule 31 displayed in the display 23 of the DTV 1 to the display according to time or the display according to channels by operating the display switching button of the remote controller 3. At this time, the coordinated program schedule in which the time axis is set in the horizontal direction and the channel axis is set in the vertical direction is displayed, therefore, the user can search the program without changing consciousness for the time direction regardless of the display form.

In addition, the user can easily switch the channel or the program as the object to be focused by operating upper and lower/right and left buttons of the remote controller 3.

Next, display switching processing of the program schedule which is executed in the DTV 1 will be explained with reference to a flow chart of FIG. 8.

In step S1, the CPU 11 judges whether a display of the program schedule has been instructed or not based on a signal corresponding to user's operation by the remote controller 3 which has been received at the light receiving unit 13, and waits until the display of the program schedule is instructed. Then, in the case that the display of the program schedule has been instructed, the process proceeds to step S2.

In step S2, the OSD additional circuit 22 reads out program schedule data stored in the memory 12 in accordance with control by the CPU 11 and generates video data to display the program schedule according to time in the display 23. The video processing circuit 21 displays the program schedule according to time in the display 23 based on the video data generated by the OSD additional circuit 22. Accordingly, for example, the program schedule 31 according to time is displayed, in which the time axis is set in the horizontal axis direction and the channel axis is set in the vertical axis direction orthogonal thereto as shown in FIG. 2.

In step S3, the CPU 11 judges whether the display switching button of the remote controller 3 has been pressed down or not by the user. When it is judged that the display switching button has not been pressed down, the process proceed to step S4, and whether the upper button or the lower button of the remote controller 3 has been pressed down or not by the user is judged.

In step S4, when it is judged that the upper button or the lower button of the remote controller 3 has been pressed down, the process proceeds to step S5, and the OSD additional circuit 22 displays the program schedule according to time in which the object of the channel to be focused is switched in the display 23 through the video processing circuit 21. For example, when the upper button of the remote controller 3 is pressed down by the user in the state that the “CC program 2” broadcasted by the “CC broadcasting network” is focused as shown in FIG. 6, the object to be focused is switched to the “BB program 2” broadcasted by the “BB broadcasting network” as shown in FIG. 7.

In step S4, when it is judged that the upper button or the lower button of the remote controller 3 has not been pressed down, the process proceed to step S6, and the CPU 11 further judges whether the right button or the left button of the remote controller 3 has been pressed down or not by the user.

In step S6, when it is judged that the right button or the left button of the remote controller 3 has been pressed down, the process proceeds to step S7, and the OSD additional circuit 22 displays the program schedule according to time in which the time slot of the program to be displayed is switched in the display 23 through the video processing circuit 21. For example, when the right button of the remote controller 3 is pressed down by the user in the state that the tab 32 of “Dec. 1, 10:30 AM” is selected as shown in FIG. 2, the tab 32 of “Dec. 1, 11:00 AM” is selected and the display of information of the program is switched as shown in FIG. 6.

In step S6, when it is judged that the right button or the left button of the remote controller 3 has not been pressed down, after the processing of step S5 or the processing of step S7 is completed, the process proceeds to step S14.

In step S3, when it is judged that the display switching button of the remote controller 3 has been pressed down, the process proceeds to step S8, and the OSD additional circuit 22 generates video data of the program schedule according to channels in accordance with control by the CPU 11. The video processing circuit 21 displays the program schedule according to channels in the display 23 based on the video data generated by the OSD additional circuit 22.

For example, when the display switching button of the remote controller 3 is pressed down by the user in a state that the program schedule according to time is displayed as shown in FIG. 2, the program schedule 31 according to channels is displayed, in which the time axis is set in the horizontal axis direction and the channel axis is set in the vertical axis direction orthogonal thereto as shown in FIG. 3. That is, in the case of the example of FIG. 3, a wider area than the other channels is assigned to the “CC broadcasting network” as the channel which has been focused in the state of FIG. 2, and information of respective programs broadcasted in the “CC broadcasting network” are displayed at positions corresponding to broadcast time of respective programs, and the “CC program 1” which has been focused in the state of FIG. 2 is focused continuously.

In step S9, the CPU 11 judges whether the display switching button of the remote controller 3 has been pressed down or not by the user.

When the CPU 11 judges that the display switching button of the remote controller 3 has been pressed down in step S9, the process returns to step S2, and the processes from the step 2 are repeated.

On the other hand, in step S9, when the CPU 11 judges that the display switching button has not been pressed down, the process proceeds to step S10, and the CPU 11 further judges whether the upper button or the lower button of the remote controller 3 has been pressed or not by the user.

In step S10, when judged that the upper button or the lower button of the remote controller 3 has been pressed down, the process proceeds to step S11, and the OSD additional circuit 22 displays the program schedule according to channels in the display 23, in which the focus channel is switched through the video processing circuit 21. For example, when the lower button of the remote controller 3 has been pressed down by the user in the state that the “CC program 1”, broadcasted by the “CC broadcasting network” is focused as shown in FIG. 3, a wider area is assigned to the “DD broadcasting network”, and the object to be focused is switched to the “DD program 1” broadcasted at the same time as the “CC program 1” which has been focused in the state of FIG. 3 as shown in FIG. 4.

In step S10, when it is judged that the upper button or the lower button of the remote controller 3 has not pressed down, the process proceed to step S12, and the CPU 11 further judges whether the right button or the left button of the remote controller 3 has been pressed down or not by the user.

In step S12, when it is judged that the right button or the left button of the remote controller 3 has been pressed down, the process proceeds to step S13, and the OSD additional circuit 22 displays the program schedule according to channels in the display 23, in which the object program to be focused is switched through the video processing circuit 21 without changing the channel. For example, when the right button of the remote controller has been pressed down by the user in the state that the “CC program 1” broadcasted by the “CC broadcasting network” is focused as shown in FIG. 3, the object to be focused is switched from the “CC program 1” to the “CC program 2” as shown in FIG. 5.

In step S12, when it is judged that the right button or the left button of the remote controller 3 has not been pressed down, after the processing of step S11 or the processing of step S13 is completed, the process proceeds to step S14.

In step S14, the CPU 11 judges whether completion of program schedule display has been instructed or not by operation of the remote controller 3 by the user, and when judging that the completion of program schedule display has not been instructed, the process returns to step S3, and the above processes are executed again.

The CPU 11, when judges that the completion of display of the program schedule has been instructed in step S14, ends the display switching processing of the program schedule.

As described above, the display of the program schedule is coordinated by setting the time axis in the horizontal direction and setting the channel axis in the vertical axis, therefore, the user can perform switching between the display according to time and the display according to channels seamlessly without a sense of incongruity. Accordingly, the user can search programs without changing consciousness for the time direction.

In the above configuration, the coordinated program schedule is displayed, in which the time axis is set in the horizontal direction and the channel axis is set in the vertical direction, however, the invention is not limited to this, and it is also preferable that a coordinated program schedule is displayed, in which the time axis is set in the vertical direction and the channel axis is set in the horizontal direction.

Additionally, in the above configuration, the program schedule as shown from FIG. 2 to FIG. 7 are displayed by the DTV 1, however, it is also preferable that they are displayed in recording equipment such as a hard disk recorder or a DVD recorder, or various equipment applying EPG.

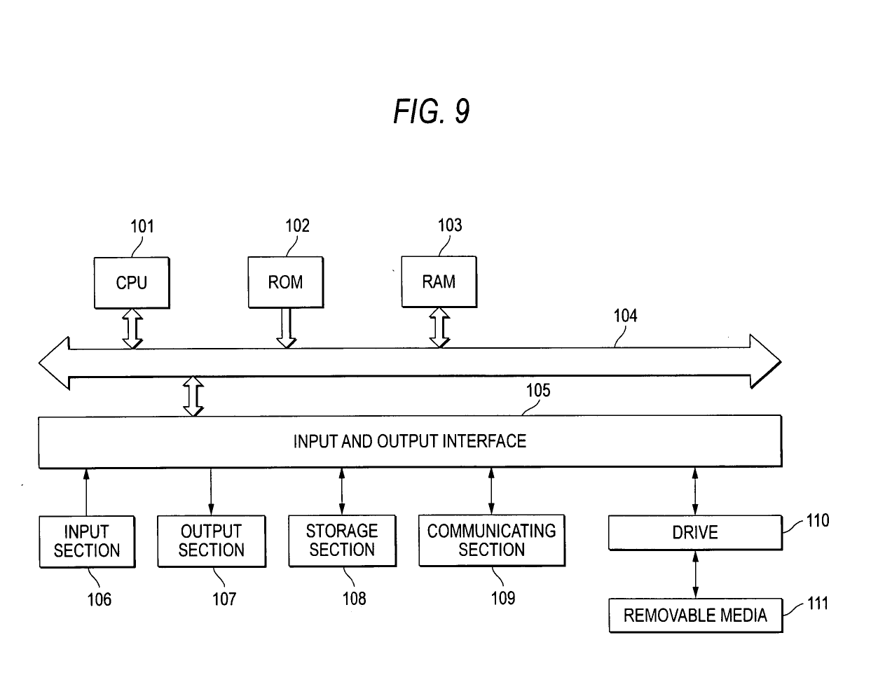

The above series of processing can be executed by hardware, however they can be executed by software. In,this case, an apparatus on which the software runs includes, for example, a computer as shown in FIG. 9.

In FIG. 9, a CPU 101 executes various processing in accordance with programs stored in a ROM (Read Only Memory) 102, or programs loaded from a storage section 108 to a RAM (Random Access Memory) 103. In addition, necessary data and the like for executing various kinds of processing by the CPU 101 are appropriately stored in the RAM 103.

The CPU 101, the ROM 102 and the RAM 103 are connected to one another through a bus 104. An input and output interface 105 is also connected to the bus 104.

To the input and output interface 105, an input section 106 having a keyboard, a mouse and the like, an output section 107 having a display including LCD (liquid Crystal Display) and so on, a speaker and the like, the storage section 108 having a hard disk and the like, and a communication section 109 performing communication processing through a network such as internet are connected.

To the input and output interface 105, a drive 110 is also connected if necessary. On the drive 110, removable media 111 including a magnetic disk, an optical disk, a magneto-optical disk, a semiconductor memory and the like are suitably loaded, and computer programs read out therefrom are installed in the storage section 108 if necessary.

In the case the series of processing is allowed to be executed by software, programs included in the software are installed from a network or storage media to a computer incorporated in a dedicated hardware, or for example, a general-purpose personal computer and the like which can execute various kinds of functions by installing various kinds of programs.

As shown in FIG. 9, the storage media is configured by not only the removable media Ill including the magnetic disk (including a flexible disk), the optical disk (including CD-ROM (Compact Disk-Read Only Memory) and DVD (Digital Versatile Disk), the magneto-optical disk (including “MD (Registered Trademark of Sony Corporation) ” (Mini-Disk)), the semiconductor memory or the like, which are distributed to the user for providing programs separately from the apparatus body, in which programs are stored, but also the ROM 102, the hard disk and the like included in the storage section 108, which are provided to the user in a state incorporated in the apparatus body in advance, in which programs are stored.

In the specification, respective steps include not only processes performed in time series in accordance with the written order but also processes performed in parallel or separately, even through the process is not always performed in time series.

It should be understood by those skilled in the art that various modifications, combinations, sub-combinations and alterations may occur depending on design requirements and other factors insofar as they are within the scope of the appended claims or the equivalents thereof.

1. A display control apparatus, comprising:
a display control unit which,
when display switching is instructed in a state that information of programs broadcasted in plural channels are displayed at positions corresponding to the broadcast time of respective programs by setting a time axis in a predetermined direction and setting a channel axis in a direction orthogonal to the predetermined direction,
displays information of programs broadcasted in a focused channel at positions corresponding to the broadcast time of respective programs by setting the time axis in the same direction as the predetermined direction, and displays information of programs by switching the focused channel in accordance with operations in the direction orthogonal to the predetermined direction by a user.

2. The display control apparatus according to claim 1,
wherein the display control unit displays frames indicating the broadcast time of programs broadcasted in different channels from the focused channel at positions corresponding to the broadcast time of respective programs.

3. The display control apparatus according to claim 2,
wherein the display control unit displays information of the programs in the frames indicating the broadcast time of the programs broadcasted in the different channels from the focused channel.

4. The display control apparatus according to claim 3,
wherein the display control unit displays information displayed in the frames indicating the broadcast time of programs broadcasted in different channels from the focused channel in a smaller size than the display of information of the programs broadcasted in the focused channel.

5. The display control apparatus according to claim 2,
wherein the display control unit, when displaying information of programs broadcasted in the focused channel, displays the program by assigning a wider area than the programs broadcasted in channels different from the focused channel.

6. The display control apparatus according to claim 1,
wherein the display control unit displays detailed information of a focused program at a designated position.

7. The display control apparatus according to claim 1,
wherein the display control unit displays a program which has been watched just before the information of programs are displayed at a designated position.

8. The display control apparatus according to claim 1,
wherein the information of programs includes picture images concerning the programs.

9. The display control apparatus according to claim 1,
wherein the program broadcasted in the focused channel is a program which is focused by a cursor.

10. The display control apparatus according to claim 9,
wherein, when the display switching is instructed, the program which has been focused in the program information displayed just before is focused and displayed continuously.

11. The display control apparatus according to claim 1,
wherein the program broadcasted in the focused channel is a colored program.

12. A display control method, comprising:
when display switching is instructed in a state that information of programs broadcasted in plural channels are displayed at positions corresponding to the broadcast time of respective programs by setting a time axis in a predetermined direction and setting a channel axis in a direction orthogonal to the predetermined direction,
displaying information of programs broadcasted in a focused channel at positions corresponding to the broadcast time of the respective programs by setting the time axis in the same direction as the predetermined direction; and
displaying information of programs by switching the focused channel in accordance with operations in the direction orthogonal to the predetermined direction by a user.

13. A program product which allows a computer to execute processing, comprising:
when display switching is instructed in a state that information of programs broadcasted in plural channels are displayed at positions corresponding to the broadcast time of respective programs by setting a time axis in a predetermined direction and setting a channel axis in a direction orthogonal to the predetermined direction,
displaying information of programs broadcasted in a focused channel at positions corresponding to the broadcast time of the respective programs by setting the time axis in the same direction as the predetermined direction; and
displaying information of programs by switching the focused channel in accordance with operations in the direction orthogonal to the predetermined direction by a user.
